(19) United States
(12) Patent Application Publication
(10) Pub. No.: US 2010/0280889 A1
(43) Pub. Date: Nov. 4, 2010

(54) INVENTORY AGGREGATION ON AN ELECTRONIC EXCHANGE

(75) Inventors: Melanie Gabriel, San Francisco, CA (US); Sundar Seshadri, Santa Clara, CA (US); Robert van Gent, Redwood City, CA (US); Venkatesh B. Natrajan, Almaden Valley, CA (US); Stephan Cunningham, Pasadena, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., a Delaware corporation, Sunnyvale, CA (US)

(21) Appl. No.: 12/435,351

(22) Filed: May 4, 2009

(51) Int. Cl. G06Q 30/00

(52) U.S. Cl. 705/14.4; 705/26; 705/14.73

(57) ABSTRACT

The subject matter disclosed herein relates to online advertising inventory purchase controls.

### BACKGROUND

1. Field

The subject matter disclosed herein relates to data processing, and more particularly to methods and apparatuses that may be implemented for advertising inventory controls through one or more computing platforms and/or other like devices.

2. Information

Advertising is everywhere. Advertisements may be found in nearly every medium of expression throughout much of human history. Advertisements may be found in our most modern medium of expression: the online world. Increased use and availability by consumers of the online world presents opportunities for advertisers to reach audiences unprecedented on a historical scale. Likewise, the online world also presents opportunity for those that own or operate online advertising space to generate advertising revenue.

While a marriage between those that wish to advertise and those that own space would appear harmonious, the reality is quite the opposite. One reason, for example, is that the marketplace to join potential purchasers with potential sellers of relevant online advertising space is inefficient and costly.

Electronic exchanges aim to provide a high degree of trading efficiency by bringing together a large number of buyers and sellers. Such exchanges are focused on directly matching the bids and offers of buyers and sellers. Conventional transactions on the exchange are between (i) buyers and sellers, (ii) intermediaries (e.g., brokers, which may be a buyer or seller), or (iii) buyers or sellers and intermediaries.

The proliferation of Internet activity has generated tremendous growth for advertising on the Internet. Typically, advertisers (i.e., buyers of ad space) and online publishers (sellers of ad space) may have agreements with one or more advertising networks (“ad networks”) or publishers to serve an advertiser's ad on one or many sites and concomitantly provide for each publisher having access to a large number of advertisers. Ad networks (which may also manage invoicing, payment, and reporting) may also attempt to target certain Internet users with particular advertisements to increase the likelihood that the user will take an action with respect to an ad. From an advertiser's perspective, effective targeting may be useful in achieving a high return on investment (ROI).

In this context, an ad network may comprise a company, enterprise or organization that facilitates communication with and/or between websites offering to host advertisements for parties desiring such advertisement. In one particular implementation, such an ad network may be implemented as a seat holder on an electronic exchange. Here, for example, “seat holders” on such an electronic exchange implementing an ad network may include companies such as, for example, advertising agencies, large publishers such as MySpace.com, CNN, as well as smaller website operators.

Online advertising markets may exhibit undesirable inefficiencies when buyers and sellers are unable to transact. For instance, although a publisher may be subscribed to many ad networks, and one or more of those ad networks may transact advertising inventory with other ad networks, only one of the ad networks to which the publisher is subscribed may be involved in selling (e.g., auctioning or guaranteeing delivery) a given ad space for the publisher. The publisher, or a gatekeeper used by the publisher, may select or prioritize which ad network (or advertiser having a direct agreement with the publisher) will serve the impression for a given ad request. In addition, advertisers who seek to reach a large audience may have to work with many publishers to ensure proper reach. Such a process of creating separate online advertising purchases with each publisher is inefficient and not scalable.

### BRIEF DESCRIPTION OF DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description when read with the accompanying drawings in which:

FIG. 1 is a schematic diagram depicting an embodiment of a system to communicate electronically regarding online advertising inventory via an electronic exchange system.

FIG. 2 is a directed graph representing entities doing business on an electronic exchange system in accordance with one or more embodiments.

FIG. 3 is a flow diagram illustrating a procedure for purchasing of online advertising inventory in accordance with one or more embodiments.

FIG. 4 is a schematic diagram depicting a set of restrictions associated with a deal tag in accordance with one or more embodiments.

FIG. 5 is schematic a block diagram illustrating an embodiment of a computing environment system in accordance with one or more exemplary embodiments.

Reference is made in the following detailed description to the accompanying drawings, which form a part hereof, wherein like numerals may designate like parts throughout to indicate corresponding or analogous elements. It will be appreciated that for simplicity and/or clarity of illustration, elements illustrated in the figures have not necessarily been drawn to scale. For example, the dimensions of some of the elements may be exaggerated relative to other elements for clarity. Further, it is to be understood that other embodiments may be utilized and structural and/or logical changes may be made without departing from the scope of claimed subject matter. It should also be noted that directions and references, for example, up, down, top, bottom, and so on, may be used to facilitate the discussion of the drawings and are not intended to restrict the application of claimed subject matter. Therefore, the following detailed description is not to be taken in a limiting sense and the scope of claimed subject matter defined by the appended claims and their equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

On an electronic exchange system, a web site publisher or ad network representing the web site publisher, otherwise known as a “Seller” on an electronic exchange, may make its advertising inventory available directly to an advertiser, an agency acting on behalf of an advertiser, or ad network acting on behalf of the advertiser, otherwise known as a “Buyer.” In one implementation, an electronic exchange may model interactions and/or transactions between Buyers and Sellers using a directed graph by establishing a relationship represented in a directed graph as a “directed edge” from a Buyer to a Seller. However, in some cases, it is desirable for multiple Sellers to pool their inventory and make the aggregate pooled advertisement inventory available to Buyers. Continuing with the directed graph model, one way to solve this problem is to create a “virtual node” on virtual network, which is modeled on an electronic exchange system. Directed edges may be created from such a virtual node to the Sellers that wish to pool their inventory together. Buyers may then create directed edges to such a virtual node to perform an online advertising inventory purchase of such a pooled inventory.

In this context, a Buyer or a Seller may comprise a “seat holder” on an electronic exchange implementing an ad network. In some implementations, such a seat holder on such an electronic exchange acting as a Buyer may comprise an advertising agency, another ad network or advertisers. In other implementations, large ad networks (e.g.,Yahoo Ad Network, Ad.com, CPX Interactive and Google) as well as large website publishers (such as MySpace, CNN, Martha Stewart Omnimedia) may act as both Buyers and Sellers on an electronic exchange.

According to an embodiment, a virtual ad network may enable smaller publishers of advertising content to pool inventory to become collectively more competitive for larger advertising budgets. In one particular embodiment, such smaller publishers may, under a predefined arrangement, agree to share pooled revenue. Pooling of revenue under such a predefined arrangement may assist in mitigating the risk to a small publisher of the loss of revenue from any single Buyer, for example. Also, to the extent legal, such a pooling of advertising revenue may give the smaller publishers greater bargaining power in dealing with larger Buyers. It should be understood, however, that these are merely examples of some of the benefits of pooling of advertising inventory in particular implementations and that claimed subject matter is not limited in this respect.

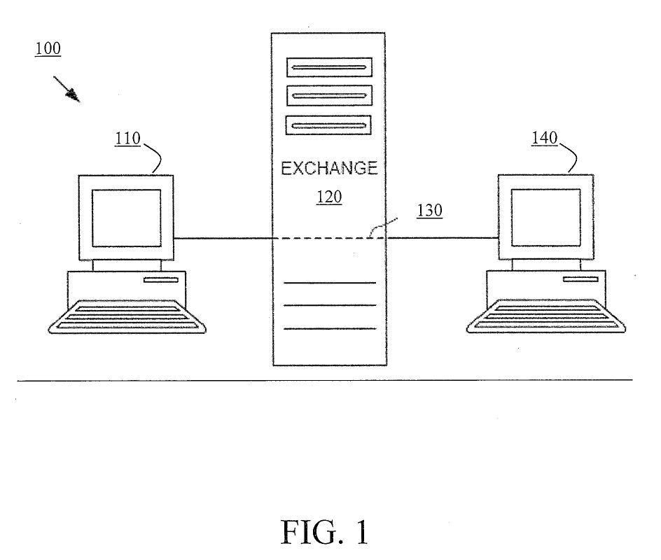

FIG. 1 depicts a system 100 to communicate electronically regarding online advertising inventory via an electronic exchange system 120. In one particular implementation, electronic exchange system 120 may be hosted on one or more special purpose computing apparatuses. In this example, a special purpose computing apparatus of a buyer 110 may be communicatively coupled to a special purpose computing apparatus hosting electronic exchange system 120. As pointed out above, such a buyer 110 may include an advertiser, an ad network, agency, and/or the like. Here, examples of ad networks may include Yahoo! Ad Network, ValueClick, Tacoda, 24/7 Real Media, CPX Interactive, Advertising.com or Google, just to name a few examples. Examples of advertising agencies include WPP, Publicis, Digitas, aQuantive or Avenue A/Razorfish, just to name a few examples.

Similarly, a special purpose computing apparatus of seller 140 may be communicatively coupled to electronic exchange system 120. Such a seller 140 may include a holder of online advertising inventory. For example, such a seller 140 may include a publisher, online content provider, and/or the like. Seller 140 may own or otherwise control online advertising inventory, such as owning or providing content for one or more online sites or networks, for example. Additionally or alternatively, seller 140 may act as an agent for one or more entities that own or control content on one or more sites or networks, as another example.

As used herein, the term “online advertising inventory” may represent advertising space available on a webpage operated, controlled, and/or represented by seller 140; and/or “online advertising inventory” may represent advertising space available on the Internet or an intranet, which may or may not include being accessible via the World Wide Web. Such online advertising inventory may include, for example, audio or visual advertising inventory available on websites, RSS feeds, blogs, instant messaging applications, adware, e-mails and/or other sources. Advertising inventory may take the form of display ads (including, for example, banners, skyscrapers, rectangulars, flash ads and video ads) rich media, text links, text messages or e-mail messages, just to name a few examples. In particular implementations, such advertising inventory may be provided according to standard advertising units such as standard advertising units defined by the Interactive Advertising Bureau. Likewise, online advertising inventory may also represent not just the advertising space itself, but particular characteristics or attributes of the inventory, such as its content, size, positioning, and audience demographic or behavioral characteristics or attributes, as non-limiting examples.

In this example, electronic exchange system 120 may act as a kind of agent or intermediary for seller 140. However, in other embodiments, electronic exchange system 120 may act as a kind of agent or intermediary for one or more buyers or sellers, or any combination thereof. Additionally or alternatively, special purpose computing apparatus of a buyer 110 may communicate with electronic exchange system 120 via the World Wide Web, Web services and/or other communication paths, regarding online advertising inventory owned or operated by seller 140. Accordingly, buyer 110 may be capable of communicating with an online advertising inventory reservation system of electronic exchange system 120. Such an inventory reservation system of electronic exchange system 120 may be capable of facilitating transactions of online advertising inventory between buyer 110 and seller 140.

In addition, a path 130 may represent an authorized link between buyer 110 and seller 140. For example, path 130 may refer to a connection between buyer 110 and seller 140 and may be referred to as a path on electronic exchange system 120. Such a path 130 may traverse zero or more other entities in a virtual network modeled on electronic exchange system 120, each of which may be considered to be an intermediary in a transaction for seller 140 to provide advertising for buyer 110.

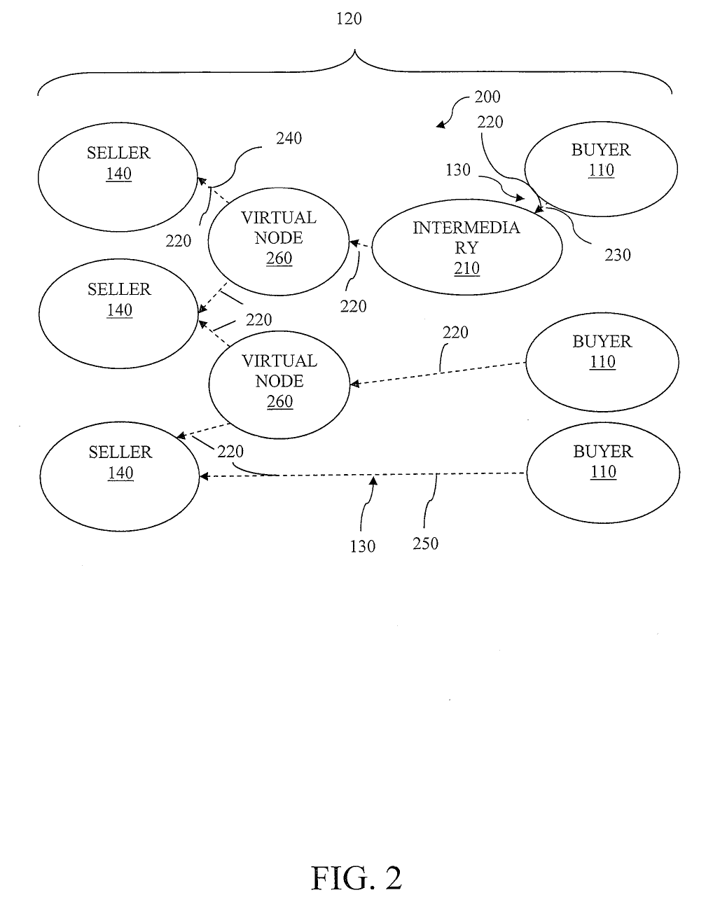

Referring to FIG. 2, and as mentioned above, electronic exchange system 120 may model transactions between and/or among entities as a directed graph 200 of nodes, where individual nodes represent an entity doing business on the electronic exchange system 120. For example, an online advertising inventory purchase on electronic exchange system 120 may be represented as a traversal of this directed graph 200. An individual online advertising inventory purchase may originate from an entity node (buyer 110) and may terminate at an entity node (seller 140). Such an online advertising inventory purchase may be represented by path 130 on electronic exchange system 120.

As illustrated in FIG. 2, directed edges represent transactions between two entities represented by nodes connected by the directed edges. In the particular implementation of FIG. 2, the direction of directed edges may represent the flow of revenue from buyers 110 or to sellers 140 in the associated transactions. Additionally, directed edges, virtual nodes 260 and nodes associated with buyers 110 and sellers 140 may be represented by data structures which are stored in a memory of a special purpose computing platform as signals. As such, it should be understood that throughout this disclosure, a “path,” “directed edge” or “node” refers to a representation of such a path, directed edge or node as one or more signals (e.g., one or more signals stored in a memory accessible by a special purpose computing apparatus).

Such a path 130 may go through zero or more other entities on the exchange, each of which may be considered to be an “intermediary”’ in the transaction, illustrated at item 210. An individual path 130 may include one or more ‘directed edges’ or ‘hops’, illustrated as directed edges 220. Individual directed edges 220 may have a buyer endpoint, which may be associated with a buyer 110 or an intermediary 210, and a seller end-point, which may be associated with a seller 140 or an intermediary 210. A buyer end-point of a first such directed edge 230 may be the original buyer 110 in an online advertising inventory purchase. Similarly, a seller end-point of a last such directed edge 240 may be the original seller 140 in an online advertising inventory purchase. Accordingly, as used herein the term “directed edge” may refer to at least a portion of a path on electronic exchange system 120, where individual edges may have a buyer endpoint (associated with an entity) and a seller end-point (associated with another entity). Path 130, for example, may have been authorized by seller 140 after a request by buyer 110. Path 130 may serve as link for buyer 110 to communicate with seller 140. Alternatively and/or additionally, seller 140 may have created or authorized one or more paths 130 to one or more similar or different buyers 110.

Additionally or alternatively, a seller 140 may also act as a buyer 110 and buy from aggregated inventory of virtual node 260. For example, an ad network representing both advertisers and publishers may act as a buyer 110 and a seller 140. Here, such an ad network may sell publishing inventory or purchase such inventory on behalf of its clients through a virtual node 260. Here, it should be understood that if such an ad network is purchasing publishing inventory, such an action may be represented as an arrow in the directed graph beginning at the ad network and terminating at a virtual node 260. Likewise, if such an ad network is selling publishing inventory, such an action may be represented as an arrow in the directed graph beginning at a virtual node 260 and terminating at the ad network.

On electronic exchange system 120, seller 140 may make its inventory available directly to a buyer 110. For example, a directed edge 250 may be established from the advertiser, agency, or ad network associated with a buyer 110 to the publisher or ad network associated with a seller 140. However, in some cases, it may be useful to pool their inventory from one or more sellers 140 and make an aggregate inventory available to buyers 110. As pointed out above, such an aggregate inventory may allow for an increased inventory pool for larger online advertising inventory purchases. Further, such an aggregate inventory may allow for more targeted ad campaigns. Additionally, such an aggregate inventory may allow for spreading risk (e.g., risk associated with a single or a few large buyers) across more than one seller. Further, such an aggregate inventory enables a buyer to establish one online advertising purchase that span across two or more sellers. In contrast, in certain systems that do not allow for pooling, a buyer 110 may make individual purchases of on-line inventory via individual order placements with individual sellers 140 with which the buyer 110 desires to purchase inventory. With aggregation, however, such a buyer 110 may submit a single order to a virtual node 260 for the purchase advertisement from an aggregated pool of inventory (available from multiple individual sellers 140). Accordingly, such a buyer 110 may purchase advertising inventory from multiple sellers 140 through a single transaction with a virtual node 260 instead of multiple, independent, transactions with multiple sellers 140.

Likewise, as mentioned above, by selling advertising inventory through a single virtual node 260, multiple sellers 140 may mitigate the risk associated with loss of revenue from any single buyer 110. Here, for example, such a single virtual node 260 may enable a seller 140 to advertise for multiple buyers 110. If a single buyer 110 stops advertising through a single virtual node 260, the loss of revenue from the single buyer 110 may be spread over multiple sellers 140 providing advertising for the particular buyer 110. In another implementation, as pointed out above, multiple sellers 140 may agree in advance to share revenue from multiple buyers over a predetermined arrangement.

According to an embodiment one or more virtual nodes 260 may be established and/or modeled on electronic exchange system 120. As used herein the term “virtual node” may refer to an association of two or more sellers 140 to pool inventory between or among such sellers 140 on electronic exchange system 120. According to an embodiment, a “virtual node” defined in a “virtual network” hosted on an electronic exchange system may associate two or more sellers via corresponding two or more of directed edges. Directed edges 240 may be created from an individual virtual node to two or more sellers 140 desiring to pool their inventory into an aggregation of advertising inventory. Buyers 110 can create directed edges 230 to a virtual node 260 directly or through one or more intermediaries 210 to enable an online advertising inventory purchase of the pooled inventory.

Additionally or alternatively, such a virtual node 260 may provide aggregated access to the inventory of a single corporate entity represented as multiple seller 140 nodes on electronic exchange system 120. For example, a global business might represent itself as multiple seller 140 nodes, one for each arm of the business, but wish to expose its inventory in a unified way. In a further example, such a virtual node 260 may provide aggregated inventory across sellers that share a common interest. For example, a group of newspapers may agree to aggregate their inventory on electronic exchange system 120 via such a virtual node 260. In another example, such a virtual node 260 may provide aggregated inventory across sellers based on a common theme. For example, a group of publishers could pool sports related inventory via such a virtual node 260. Such aggregated inventory may be exposed from such a virtual node 260 to any number of advertisers, agencies, or ad networks via buyer 110 nodes, at the discretion of the group of virtually networked seller 140, by creating links from buyer 110 node to virtual node 260.

According to an embodiment, a virtual node 260 may be defined in a virtual network hosted on a special purpose computing apparatus (e.g., as part of an electronic exchange system) to, among other things, communicate with nodes in the virtual network associated with one or more buyers 110 nodes and a plurality of sellers. Here, for example, such a special purpose computing apparatus may maintain signals representative of an aggregation of advertising inventory associated with a plurality of sellers 140 in a memory accessible by the special purpose computing apparatus. In one particular implementation, the special purpose computing apparatus may receive one or more signals from an electronic communication network representative of a request from a buyer 110. For example, such signals may be transmitted from a computing apparatus associated with a buyer 110 node according to any one of several communication protocols over any one of several electronic data transmission mediums. In response, a special purpose computing apparatus hosting an electronic exchange system defining virtual node 260 may transmit one or more signals on the electronic communication network representative of a transaction to sell advertisement in the aggregation of advertising inventory from at least two sellers 140.

According to an embodiment, although claimed subject matter is not limited in this respect, a special purpose computing apparatus hosting an electronic exchange system defining a virtual node 260 may receive signals from an electronic communication network originating at special purpose computing apparatuses associated with buyer 110 nodes and seller 140 nodes. In one particular implementation, a special purpose computing apparatus hosting the electronic exchange system may store signals representative of an aggregation of available advertising inventory in a memory based, at least in part, on signals received from special computing apparatuses associated with seller 140 nodes representative of advertising inventory available at and/or offered by the seller 140 nodes.

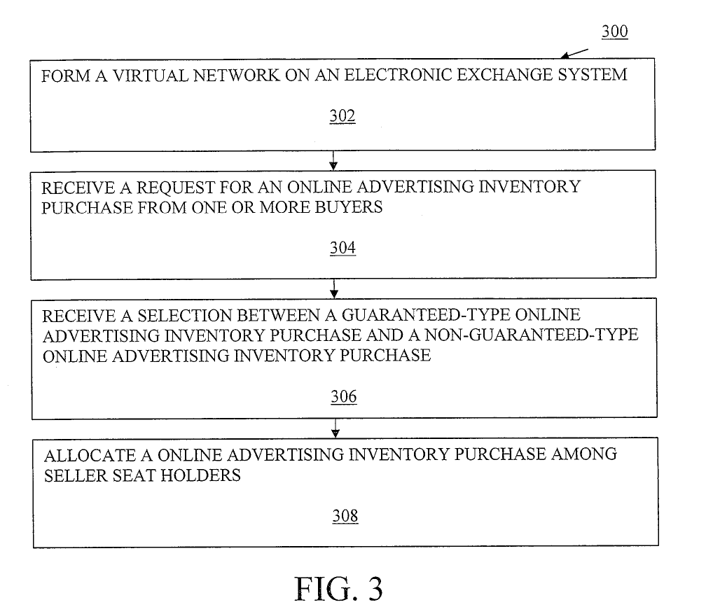

Referring to FIG. 3, a flow diagram illustrates a process for purchasing of online advertising inventory in accordance with one or more embodiments. Although process 300, as shown in FIG. 3, comprises one particular order of actions, the order in which the actions are presented does not necessarily limit claimed subject matter to any particular order. Likewise, intervening actions not shown in FIG. 3 and/or additional actions not shown in FIG. 3 may be employed and/or actions shown in FIG. 3 may be eliminated, without departing from the scope of claimed subject matter.

Process 300 depicted in FIG. 3 may in alternative embodiments be implemented in software, hardware, and/or firmware, and may comprise discrete operations. As illustrated, at action 302, a virtual network may be formed on an electronic exchange system 120 (FIG. 1) (e.g., which is hosted on a special purpose computing apparatus). For example, such a virtual network may include two or more sellers 140 (FIG. 1) on electronic exchange system 120 (FIG. 1). Additionally or alternatively, such a virtual network may include a virtual node 260 (FIG. 2) on electronic exchange system 120 (FIG. 1) associated with two or more sellers 140 (FIG. 1) via corresponding two or more directed edges 240 (FIG. 2).

At action 304, a request for an online advertising inventory purchase may be received. For example, such a request for an online advertising inventory purchase may be received via electronic exchange system 120 (FIG. 1) as an electronic communication from one or more buyers 110 (FIG. 1).

At action 306, a selection between a guaranteed-type online advertising inventory purchase and a non-guaranteed-type online advertising inventory purchase may be received. For example, an electronic exchange system 120 (FIG. 1) may receive an electronic communication from a seller 140 (FIG. 1) and/or a buyer 110 (FIG. 1). Such an electronic communication from a seller 140 (FIG. 1) and/or a buyer 110 (FIG. 1) may include a selection between a guaranteed-type online advertising inventory purchase and a non-guaranteed-type online advertising inventory purchase. In such a case, a requested online advertising inventory purchase, referred to at action 304, may include a guaranteed-type online advertising inventory purchase and/or a non-guaranteed-type online advertising inventory purchase. As used herein, the term “non-guaranteed-type online advertising inventory purchase” may refer to an online advertising inventory purchase request that is contingent upon the selection of such a request, such as by winning a bidding process, for example. Conversely, the term “guaranteed-type online advertising inventory purchase” may refer to an online advertising inventory purchase request that is not contingent upon any such bidding process.

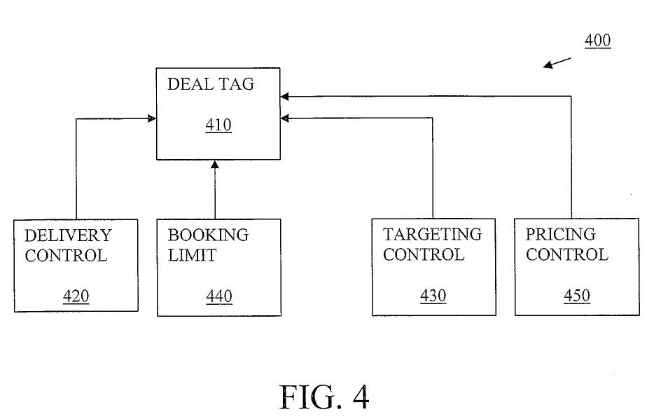

For example, referring back to FIG. 1, any two entities on electronic exchange system 120 may enter into an agreement to buy placements for guaranteed ad delivery. As used herein the term “entity” may refer to buyers 110, sellers 140, and/or intermediaries 210 on electronic exchange system 120. For example, any two entities 110/140/210 (FIG. 2) (such as one or more buyers 110, one or more sellers 140, and/or one or more intermediaries 210) who are linked to each other on electronic exchange system 120 may enter into an agreement to buy placements for guaranteed ad delivery. For example, buyer 110 (FIG. 2) may enter into an agreement with the seller 140 (FIG. 2) for buyer 110 (FIG. 2) to buy placements for guaranteed delivery by seller 140 (FIG. 2). This agreement may be represented in the system as a guaranteed delivery enabling contract (GDE contract). Such a GDE contract may include without limitation a price/revenue-share which will be paid to seller 140 (FIG. 2) by buyer 110 (FIG. 2) as a result of the guaranteed transaction. Further, such a GDE contract may include the terms and conditions agreed upon by both buyer 110 (FIG. 2) and seller 140 (FIG. 2). Additionally, such a GDE contract may include delivery controls, targeting controls, pricing controls, and/or booking limits through a deal tag 410 (FIG. 4) applicable to the GDE contract.

Guaranteed ad delivery may include certain special criteria, partially described herein. For example, such guaranteed delivery may include a number of impressions reserved beforehand. Similarly, such guaranteed delivery may include a price determined at ad reservation time. There also may be a stipulated time period within which promised impressions may be required to be delivered. Also, it may be possible to reserve guaranteed delivery on a “run-of” basis, meaning an ad serving system decides where to show the ad among multiple publishers. Such “targeting controls” may refer to one or more restrictions that allow an entity 110/140/210 (FIG. 2), or its agent, to limit how online advertising inventory may be used. Numerous types of restrictions may be applied, alone or in combination, against online advertising inventory or its associated characteristics or attributes. As some non-limiting examples, such targeting controls may include restrictions to control content type, content topic, ad size or position, or target audience characteristics, such as their demographic or behavioral characteristics or attributes.

Guaranteed delivery on electronic exchange system 120 may fulfill the above criteria in the following manner. A path 130 on electronic exchange system 120 may be viable for guaranteed delivery if there are valid GDE contracts on each edge of the path 120. A GDE contract may be established along an edge by two entities 110/140/210 agreeing on a contract for ad delivery or for some other related performance. At booking time valid paths for guaranteed delivery may be determined. Such valid paths may originate from buyer 110. Such valid paths may be further trimmed by matching targeting controls defined on the GDE contract on path 130 with targeting criteria defined on by an ad campaign by buyer 110. Such trimmed valid paths may be utilized to determine available inventory and make ad reservations. For example, for individual trimmed valid paths, price/revenue-share may be pre-calculated on an individual edge basis.

Such pre-computed information of various individual edges may be associated together by the concept of a “booking” describing a given path 130 on electronic exchange system 120. Such a booking may represent a specific online advertising inventory purchase for guaranteed delivery. A booking may encapsulate without limitation the advertiser on whose behalf the ad reservation is made, the campaign/order associated with the booking, the number of impressions reserved, the start/end date of the campaign/order, a pre-computed set of one or more paths path 130 on electronic exchange system 120 that are covered by the booking. Further, “run-of” ad reservations that cover several publishers may have more than one path 130.

As discussed above, a virtual network of two or more sellers 140 may be formed via a virtual node 260 (FIG. 2) to pool inventory between such sellers 140 on electronic exchange system 120. In such a case, a guaranteed buy associated with two or more sellers 140 via a virtual node 260 (FIG. 2) may be split across the participating sellers 140. For example, a guaranteed buy may either be split across the participating sellers 140 at reservation time, or dynamically at ad delivery time. In either case, the revenue for individual participating sellers 140 may be proportional to the percentage of the ads that the individual sellers 140 serve.

Referring back to FIG. 3, at action 308, an online advertising inventory purchase may be allocated among sellers. For example, a requested online advertising inventory purchase, referred to at action 304, may include a guaranteed-type online advertising inventory purchase. In such a case, such a guaranteed-type online advertising inventory purchase may be allocated among two or more sellers of a given virtual network based at least in part on an electronic communication of a requested online advertising inventory purchase. For example, such an allocation may take place at the time of purchase and/or prior to delivery of such inventory to a target audience. Alternatively, such a guaranteed-type online advertising inventory purchase may be allocated among two or more sellers of a given virtual network based at least in part on a delivery of a requested online advertising inventory purchase. For example, such an allocation may take place at the time of and/or after delivery of such inventory to a target audience.

Embodiment 400, in FIG. 4, is a schematic diagram depicting a set of restrictions. In this embodiment, restrictions allow an entity 110/140/210 (FIG. 2) to specify if and how its online advertising inventory may be purchased or used via the application or enforcement of one or more restrictions with respect to the inventory. For example, the restrictions shown in this embodiment may, alone or in combination, be applied to online advertising inventory, including its attributes or characteristics.

Here, one or more of these restrictions may comprise deal tag 410. Furthermore, deal tag 410 may contain one or more restrictions that more specifically address how an entity 110/140/210 (FIG. 2) may control its inventory. In some embodiments, one or more restrictions may comprise a deal tag; in other embodiments, particular restrictions may be shared across one or more deal tags. For ease of description, we have grouped restrictions into the following categories: delivery controls, targeting controls, booking limits and pricing controls.

Referring back to FIG. 2, a path 130 may permit a seller 140, or an electronic exchange system 120, to apply or enforce restrictions at the path level. Accordingly, one or more restrictions may be associated with one or more paths 130 through electronic exchange system 120. For example, one or more such a deal tags 410 (FIG. 4) may be associated with one or more directed edges 230/240/250. As discussed above, one or more buyers 110 may be associated with a virtual node 260 via one or more directed edges 230/240/250. In such a case, deal tag 410 (FIG. 4) may associate one or more restrictions to on an online advertising inventory purchase by buyers 110.

In the interests of not obscuring the scope claimed subject matter, it is important to note that only a few examples were given of the types of restrictions that may be applied against inventory or its associated characteristics or attributes. Likewise, only a few examples were give regarding the characteristics or attributes of inventory. Of course, however, other restrictions may be included which may not be neatly, nor at all, be categorized as delivery controls, targeting controls, booking limits, pricing controls, or some combination thereof, that may be applied against inventory or any of its characteristics or attributes.

With respect to the application of restrictions against inventory, depending on the embodiment, one or more restrictions may be applied to online advertising inventory at a variety of levels, such as at the site, publisher, or network level, as non-limited examples. For example, an entity 110/140/210 (FIG. 2) may establish a targeting control to restrict the use of particular content for inventory on a particular site, but may allow that particular content otherwise through the rest of the entity's 110/140/210 (FIG. 2) network.

Additionally or alternatively, publishers or ad networks participating as multiple sellers 140 in a virtual node 260 may configure parameters of their participation on edges 240 located between sellers 140 and virtual node 260. For example, such parameters may be configured using one or more deal tags 410. For example, a publisher or ad network represented by seller 140 might wish to configure: the types inventory to include in the aggregated inventory of virtual node 260, what types of targeting to enable for the given inventory participating in the aggregated inventory of virtual node 260, and/or how much of their available inventory to include in the aggregated inventory of virtual node 260, and/or the like.

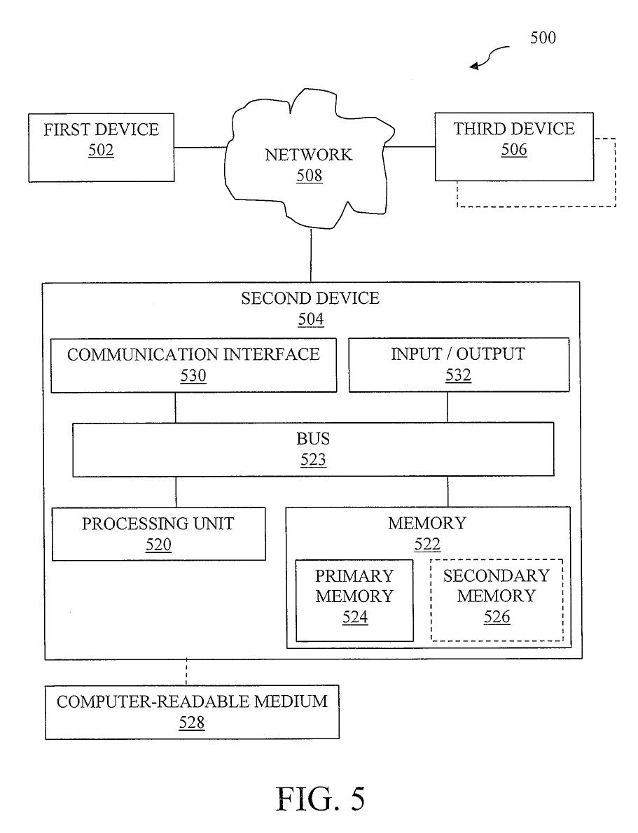

FIG. 5 is a block diagram illustrating an exemplary embodiment of a computing environment system 500 that may include one or more devices configurable to distribute data items within geographically distributed special purpose computing apparatuses using one or more exemplary techniques illustrated above. For example, computing environment system 500 may be operatively enabled to perform all or a portion of process 300 of FIG. 3.

Computing environment system 500 may include, for example, a first device 502, a second device 504 and a third device 506, which may be operatively coupled together through a network 508.

First device 502, second device 504 and third device 506, as shown in FIG. 5, are each representative of any device, appliance or machine that may be configurable to exchange data over network 508. By way of example, but not limitation, any of first device 502, second device 504, or third device 506 may include: one or more special purpose computing apparatuses and/or devices, such as, e.g., a desktop computer, a laptop computer, a workstation, a server device, storage units, or the like.

In the context of this particular patent application, the term “special purpose computing apparatus” means or refers to a general purpose computing apparatus once it is programmed to perform particular functions pursuant to instructions from program software. By way of example, but not limitation, any of first device 502, second device 504, or third device 506 may include: one or more special purpose computing apparatuses once programmed to perform particular functions pursuant to instructions from program software. Such a special purpose computing apparatus may host an electronic exchange system as discussed above according to particular embodiments. Also, such a special purpose computing apparatus may be operated and/or controlled by a Buyer or Seller.

Network 508, as shown in FIG. 5, is representative of one or more communication links, processes, and/or resources configurable to support the exchange of data between at least two of first device 502, second device 504 and third device 506. By way of example, but not limitation, network 508 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

As illustrated by the dashed lined box partially obscured behind third device 506, there may be additional like devices operatively coupled to network 508, for example.

It is recognized that all or part of the various devices and networks shown in system 500, and the processes and methods as further described herein, may be implemented using or otherwise include hardware, firmware, software, or any combination thereof.

Thus, by way of example, but not limitation, second device 504 may include at least one processing unit 520 that is operatively coupled to a memory 522 through a bus 523.

Processing unit 520 is representative of one or more circuits configurable to perform at least a portion of a data computing procedure or process. By way of example, but not limitation, processing unit 520 may include one or more processors, controllers, microprocessors, microcontrollers, application specific integrated circuits, digital signal processors, programmable logic devices, field programmable gate arrays, and the like, or any combination thereof.

Memory 522 is representative of any data storage mechanism. Memory 522 may include, for example, a primary memory 524 and/or a secondary memory 526. Primary memory 524 may include, for example, a random access memory, read only memory, etc. While illustrated in this example as being separate from processing unit 520, it should be understood that all or part of primary memory 524 may be provided within or otherwise co-located/coupled with processing unit 520.

Secondary memory 526 may include, for example, the same or similar type of memory as primary memory and/or one or more data storage devices or systems, such as, for example, a disk drive, an optical disc drive, a tape drive, a solid state memory drive, phase change memory, etc. In certain implementations, secondary memory 526 may be operatively receptive of, or otherwise configurable to couple to, a computer-readable medium 528. Computer-readable medium 528 may include, for example, any medium that can carry and/or make accessible data, code and/or instructions for one or more of the devices in system 500.

Second device 504 may include, for example, a communication interface 530 that provides for or otherwise supports the operative coupling of second device 504 to at least network 508. By way of example, but not limitation, communication interface 530 may include a network interface device or card, a modem, a router, a switch, a transceiver, and the like.

Second device 504 may include, for example, an input/output 532. Input/output 532 is representative of one or more devices or features that may be configurable to accept or otherwise introduce human and/or machine inputs, and/or one or more devices or features that may be configurable to deliver or otherwise provide for human and/or machine outputs. By way of example, but not limitation, input/output device 532 may include an operatively enabled display, speaker, keyboard, mouse, trackball, touch screen, data port, etc.

Some portions of the detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a special purpose computing apparatus, such as a computer or a similar electronic computing device, that manipulates or transforms data represented as physical electronic or magnetic quantities within memories, registers, or other information storage devices, transmission devices, or display devices of the special purpose computing apparatus.

Reference throughout this specification to “one embodiment” or “an embodiment” means that a particular feature, structure, or characteristic described in connection with the embodiment is included in at least one embodiment of claimed subject matter. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “and/or” as referred to herein may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

1. A method, comprising:
aggregating advertising inventory associated with a plurality of sellers according to a virtual network defined in an electronic exchange system hosted on a special purpose computing apparatus;
maintaining signals representative of said aggregation of advertising inventory in a memory accessible by said special purpose computing apparatus;
receiving one or more signals from an electronic communication network representative of a request from a buyer on said electronic exchange system to purchase advertisement; and
transmitting one or more signals on said electronic communication network representative of a transaction to sell advertisement in said aggregation of advertising inventory from at least two of said sellers in response to said request.

2. The method of claim 1, wherein said signals representative of said request originate at a special purpose computing apparatus operated by said buyer and coupled to said electronic exchange system via said electronic communication network.

3. The method of claim 1, and further comprising:
receiving signals from said electronic communication network originating at special purpose computing apparatuses associated with said sellers and representative of an availability of advertising from individual sellers; and
storing said signals representative of said aggregation in said memory based, at least in part, on said signals representative of said availability.

4. The method of claim 1, wherein said virtual network comprises a virtual node associating said two or more sellers via corresponding two or more directed edges.

5. The method of claim 1, wherein said virtual network comprises a virtual node associating said plurality of sellers via associated directed edges, and wherein said buyer is associated with said virtual node via a directed edge.

6. The method of claim 1, wherein said request to purchase advertisement comprises a request to purchase guaranteed-type online advertising inventory and/or a non-guaranteed-type online advertising inventory, the method further comprising: receiving an electronic communication representative of a selection between said guaranteed-type online advertising inventory purchase and said non-guaranteed-type online advertising inventory purchase.

7. The method of claim 1, wherein said request to purchase advertisement comprises a request to purchase guaranteed-type online advertising inventory, the method further comprising:
allocating said guaranteed-type online advertising inventory purchase to said aggregation among at least two of said plurality of sellers based, at least in part, on said request to purchase.

8. The method of claim 1, wherein said request to purchase advertisement comprises a request to purchase a guaranteed-type online advertising inventory, and further comprising:
allocating said guaranteed-type online advertising inventory purchase to said aggregation among at least two of said sellers based at least in part on a delivery of said requested online advertising inventory purchase.

9. The method of claim 1, wherein said virtual network comprises a virtual node associating said plurality of sellers via an associated plurality of directed edges, wherein said buyer is associated with said virtual node via at least one of said directed edges, and further comprising processing a deal tag associated with at least one of said directed edges on said special purpose computing platform to implement one or more restrictions on a purchase of online advertising inventory.

10. The method of claim 9, wherein said deal tag specifies one or more restrictions including at least one of the following: delivery controls, targeting controls, pricing controls, booking limits, or any combination thereof.

11. The method of claim 1, wherein said aggregating further comprises pooling said aggregated advertising inventory according to a predefined arrangement to mitigate risk to said at least two of said sellers.

12. An article comprising:
a storage medium comprising machine-readable instructions stored thereon, which, if executed by one or more processing units of a special purpose computing apparatus, operatively enable said special purpose computing apparatus to:
aggregate advertising inventory associated with a plurality of sellers according to a virtual network defined in an electronic exchange system hosted on said special purpose computing apparatus;
maintain signals representative of said aggregation of advertising inventory in a memory accessible by said special purpose computing apparatus; and
initiate transmission of one or more signals on an electronic communication network representative of a transaction to sell advertisement in said aggregation of advertising inventory from at least two of said sellers in response to a request from a buyer on said electronic exchange system to purchase advertisement from said aggregation of advertising inventory.

13. The article of claim 12, wherein said virtual network comprises a virtual node on said electronic exchange system associated with said two or more sellers via corresponding two or more directed edges, wherein at least one of said buyers is associated with said virtual node via at least one of said directed edges.

14. The article of claim 13, wherein said machine-readable instructions, if executed by the one or more processing units, further operatively enable the special purpose computing apparatus to:
associate at least one deal tag with at least one of said directed edges, and wherein said deal tag comprises one or more restrictions including at least one of the following: delivery controls, targeting controls, pricing controls, booking limits, or any combination thereof.

15. The article of claim 12, wherein said request to purchase advertisement comprises a request to purchase a guaranteed-type online advertising inventory and/or non-guaranteed-type online advertising inventory, and said instructions, if executed by said one or more processors, are further operatively enable said special purpose computing apparatus to:
allocate said guaranteed-type online advertising inventory and/or non-guaranteed-type online advertising inventory purchase to said aggregation among at least two of said sellers based at least in part on a delivery of said requested online advertising inventory purchase.

16. An apparatus comprising:
a special purpose computing apparatus, said special purpose computing apparatus comprising:
a communication interface adapted to transmit signals to and/or receive signals from an electronic communication network;
one or more processors programmed with instructions to:
aggregate advertising inventory associated with a plurality of sellers according to a virtual network defined in an electronic exchange system hosted on said special purpose computing apparatus;
maintain signals representative of said aggregation of advertising inventory in a memory accessible by said special purpose computing apparatus; and
initiate transmission of one or more signals through said communication interface on said electronic communication network representative of a transaction to sell advertisement in said aggregation of advertising inventory from at least two of said sellers in response to signals received at said communication interface representative of a request from a buyer on said electronic exchange system to purchase advertisement from said aggregated advertisement inventory.

17. The apparatus of claim 16, wherein said request to purchase advertisement comprises a request to purchase a guaranteed-type online advertising inventory and/or non-guaranteed-type online advertising inventory, and wherein said one or more processors are further programmed with instructions to:
allocate said guaranteed-type online advertising inventory and/or non-guaranteed-type online advertising inventory purchase to said aggregation among at least two of said sellers based at least in part on a delivery of said requested online advertising inventory purchase.

18. The apparatus of claim 16,wherein said virtual network comprises a virtual node on said electronic exchange system associated with said two or more sellers via corresponding two or more directed edges, and wherein at least one of said buyers is associated with said virtual node via a directed edge.

19. The apparatus of claim 18, wherein said one or more processors is further programmed with instructions to:
associate at least one deal tag with at least one of said directed edges, and wherein said deal tag comprises one or more restrictions including at least one of the following: delivery controls, targeting controls, pricing controls, booking limits, or any combination thereof.

20. The apparatus of claim 16, wherein said request to purchase advertisement comprises a request to purchase a guaranteed-type online advertising inventory and/or non-guaranteed-type online advertising inventory, and wherein said one or more processors is further programmed with instructions to:
allocate said guaranteed-type online advertising inventory and/or non-guaranteed-type online advertising inventory purchase to said aggregation among at least two of said sellers based at least in part on a delivery of said requested online advertising inventory purchase.
